(19) United States
(12) Patent Application Publication
(10) Pub. No.: US 2025/0374382 A1
(43) Pub. Date: Dec. 4, 2025

(54) MULTI-BLOCK HEATING MODULE FOR LONGITUDINALLY DEVELOPING CHAMBERS

(71) Applicant: E-WENCO S.R.L., Gallarate (IT)

(72) Inventors: Chiara CREMONESI, Gallarate (IT); Davide Stefano GUERRA, Gallarate (IT); Amos Duca ROGIANI, Gallarate (IT)

(21) Appl. No.: 18/867,458

(22) PCT Filed: Jun. 7, 2023
(86) PCT No.: PCT/EP2023/065288

§ 371 Date: Nov. 20, 2024

(30) Foreign Application Priority Data
Jun. 8, 2022 (IT) 102022000012203

(51) Int. Cl. H05B 6/10

(52) U.S. Cl. CPC H05B 6/108; H05B 2203/017

(57) ABSTRACT

A longitudinally extending multi-block heating module is here disclosed. The module consists of a system with at least 6 elements of which at least: two thermo-active induced elements, a support system, a thermal break, a longitudinal septum and an inductor.

The Multi-block heating module is suitable for processes that require the management of at least two confined thermal imprints that develop along a longitudinal axis. To facilitate thermal transfer, the Multi-block heating module 100, object of the present invention, can therefore be inserted in a chamber or be itself the chamber (for example a pipe or a portion of pipe, a cubic container, a tank . . . ), used for the passage or storage or temporary permanence of fluids, liquids, gases and/or solids in direct or indirect contact with the thermal source.

### FIELD OF INVENTION

The present invention refers to a Multi-block heating module for longitudinally developing chambers, heated by induction. Multi-block induction heating modules 100 of this type can be used to heat fluids and/or solids and/or gases in motion or temporarily stationary or stored, in direct contact with or in proximity to the Multi-block induction heating module 100, object of the present invention. The Multi-block heating module 100 for longitudinally developing chambers can be placed or integrated inside a storage or passage chamber or can constitute the chamber itself. The aforementioned Module 100 can be used in the industrial or civil sector.

### STATE OF ART

Many industrial and domestic processes involve heating a fluid, solid or gas. Consider, for example, industrial drying or phase transition processes or water heating in the civil and industrial sectors.

Conventionally the heat source that heats the material is an interface, often metals or metal mixtures, which in turn can be heated by: direct contact with electrical resistances or open flame or hot fluids/gases (e.g. hot oil, steam, hot air . . . ) or wirelessly via electromagnetic induction. Furthermore, in various industrial processes it is necessary that the heating takes place locally with differential temperature gradients; a fluid, a solid or a gas may in fact require different temperatures depending on the specific position they occupy, whether they are in transit or temporarily stationed inside or near the thermal source.

A known example is constituted by the roasting processes of the coffee beans using rotary heaters where the beans, in their slow forward movement, are constantly stirred to arrive at touching in an appropriate way the heated walls of the roasting machine which are kept at different temperatures depending on the quota. The diversity of the temperatures of the walls of the pipe is obtained in a controlled way, for example, by installing different windings of electrical resistances, or different open flame burners, independent of each other and piloting their operation independently by varying the voltage of the electric power supply or by means of variations in the flow rate of fuel gas. The intrinsic weakness of this solution consists in the impossibility of varying the engagement rates of the different temperatures without resorting to replacing the installed heating elements with others of different extension along the axis of the roasting chamber or without altering the installation position of the gas burners.

A further widespread example is offered by stills or electric, saturated steam or direct flame kettles of boiling water, intended for the distillation of alcohols deriving from the processing of marcs and various aromas for the production of liqueurs. In these devices the walls of the chamber containing the pomace and the aromas and the relative vapors are kept at locally different temperatures according to the height through the combination of physiological phenomena of stratification of the water, of the vapors themselves of the various alcohols and oils and the application of heat sources located at different heights or sites and managed at different temperatures. This solution allows you to vary the feed power snapshot of each heat source with consequent local temperature change of the wall of the chamber in contact with the heaters; but they have the limitation of not being able to vary the vertical coordinate of the point of instantaneous generation of the specific boiling in vapor of the extracted constituent at the local process temperature; that forces the system to always work at a fixed rate regardless of the actual instantaneous process demand should it vary.

Furthermore, there is always a significant percentage of heat transmission in sectors which would be more appropriate to avoid heating additionally with the effect of enriching the length of the head and tail phases corresponding to the lower boiling and higher boiling alcohols which must necessarily be discarded and rework.

A further example that finds application in analysis and characterization systems, widely used in the chemical and pharmaceutical industries, is that of accelerated gas chromatographic columns for dynamic separation. In these types of apparatuses, a selective and progressive separation takes place of the constituents of a system previously linked in various capacities. This separation can take place, in an elementary form, according to the basic principles of fractional distillation. In order to increase the efficiency of the system, some devices have the ability to selectively impart kinetic energy to the freshly fractionated compounds, with the effect of allowing a more rapid evacuation towards the upper layers of the column. In order to obtain this result, the devices available on the market today make use of solutions consisting of electrical resistance windings which the qualified operator positions manually, outside the column, at the desired work height, in order to confer thermal energy in the sector which immediately follows the separation function, increasing the gas pressure and allowing for more rapid upward diffusion. However, this configuration has obvious disadvantages, including the need for manual positioning at the level/work sector of interest, the difficulty of adjustment due to the barriers represented by the walls of the column, the poor dynamic reactivity of the system, the impossibility varies the working area/mounting dimension until the attached external auxiliary heater is excessively hot.

All these limitations make desirable the possibility of having an induction heating module capable of differentiating temperatures locally along a development axis, with control precision, response speed and reduced thermal transmission effects in the sectors adjacent to those of interest. A heating system of this conformation could therefore also be used for heating tubular chambers in polymeric material, used, for example, in the food industry for the browning of foods produced in line. Objects of the invention

The object of the present invention is to provide a heating module 100 capable of supplying heat to specific areas for longitudinally developing rooms, with several thermal footprints confined to each other, thus allowing sectoral heating.

The object of the present invention is to provide a Multi-block heating module 100 suitable for heating liquids and/or solids and/or gases stored in moving or temporarily stationary chambers, in direct contact with or near the induction Multi-block heating module, object of the present invention. The object of the present invention is also to offer a heating module capable of heating sectorally, at different temperatures, liquids and/or solids and/or gases contained within the module itself and the walls of the chamber are the thermo-active elements of the module.

A further purpose of the present invention is to provide a Multi-block heating module whose thermo-active elements are internally maintained at a predetermined distance with respect to the structural support.

A further purpose of the present invention is to provide a Multi-block heating module whose thermo-active elements can maintain a low thermal inertia and allow a fine temperature control and an immediate response speed.

A different object of the present invention is to provide a Multi-block heater whose thermo-active elements have a low thermal inertia.

An important purpose of the present invention is to provide a Multi-block heating which allows to obtain a considerable thermal differentiation along the longitudinal axis and a more precise thermal control of the process.

An interesting purpose of the present invention is to provide thermo-active elements with a surface area such as to increase the heating surface of the thermo-active elements without appreciable variations in the equivalent diameter of the heating module.

Yet another purpose of the present invention is to create distinct/confined/isolated thermal footprint for each of the thermo-active elements.

Another purpose of the present invention is to provide a heating module which is highly reactive to electromagnetic fields and almost instantaneously ready to transfer thermal energy.

A further purpose of the present invention is to provide a heating module which creates spaces inside the thermo-active element to increase the contact surface with the element passing through it, increasing the heat transfer.

A further object of the present invention is to provide a heating module able to transfer differential thermal energy to liquids, gases and/or solids elements positioned externally and in proximity thereto.

### Description of the Invention

These and other purpose are achieved by means of a Multi-block heating module comprising at least:
two thermo-active elements 30, electromagnetically inducible
at least one electromagnetic inductor 40 of said thermo-active elements, arranged inside or outside said thermo-active elements
at least one structural support 20 associated with said thermo-active elements, maintaining fixed the relative spatial arrangement between said thermo-active elements at least one structural support 20
at least one thermal break 10 interposed between said at least two thermo-active elements;
characterized in that the thermo-active elements 30 are hollow and that at least one longitudinal septum 60 is present inside at least one thermo-active element 30.

In the present invention the term “chamber” is to be understood as a container of any shape or size which houses the material, in transit or stationary or temporarily stationary, to be heated through the Multi-block heating module. Furthermore, in the present invention with “chamber” we can also mean the recipient target of the thermal effects produced by the Multi-block heating module 100.

Furthermore, in the present invention “equivalent diameter” means the diameter of the circle having an area equal to that of the polygon under examination.

### Advantageous Features of the Invention

Advantageously, the thermo-active element is hollow to maintain low thermal inertia and allow fine temperature control and immediate response speed.

Advantageously, said longitudinal septum allows maintaining the position of the structural support with respect to the thermo-active element as it guarantees the required distance between the structural support and the thermo-active element.

Advantageously, the dimensions of said thermoactive element have thin walls, at least one order of magnitude smaller than the equivalent diameter of the heating module, presenting a lower thermal inertia which allows more immediate control and rapid thermal response.

Advantageously, the number and reduced length of each thermo-active element compared to the total length of the apparatus allow for greater thermal differentiation along the longitudinal axis and more precise thermal control of the process.

Advantageously, the Multi-block heating device has thermo-active elements with an embossed surface obtaining, with the same dimensions, an increase in the heating surface of the thermo-active elements without appreciable variations in the equivalent diameter of the heating module.

Advantageously, the presence and properties of the thermal cuts allow to obtain a thermal footprint of the device of the invention confined to the thermo-active element 30 receiving the electromagnetic waves, since said thermal cuts in fact, in addition to offering poor responsiveness to the electromagnetic waves, also offer optimal thermal insulation, thus presenting themselves intrinsically safe and thermally sectorial.

An advantageous feature derived from the previous implementation allows to obtain different thermal impressions along the longitudinal axis of the device of the invention.

Advantageously, the thermo-active elements are made of low thickness metal and are coupled to a support which gives said elements rigidity and structure allowing to obtain a Multi-block heating module which is very reactive to electromagnetic fields and almost instantaneously ready to transfer thermal energy.

Advantageously, said longitudinal septum is integral (for example by means of fusion, extrusion, joint, welding, subtractive processing, additive processing) with the thermo-active element to ensure greater stability and mechanical resistance.

Advantageously, said longitudinal septum is made of insulating material to avoid thermal bridges and to favor a rapid thermal response of the thermo-active elements.

Advantageously, the longitudinal septum rests on the thermo-active element and has a height lower than the distance between the thermo-active element and the structural element; thanks to this form of implementation the longitudinal septum defines chambers inside the thermo-active element which increase the hot contact surface with the element that passes through it, increasing the heat transfer.

Advantageously, said longitudinal septum is associated with the thermo-active element and with the structural element, creating a mechanical and thermal bridge between the two elements, so as to achieve one or more of the following advantages:
1) increase the mechanical properties of the thermo-active element as it becomes more resistant to pressure;
2) improve the positioning of the thermo-active element with respect to the structural element since it defines positioning guides;
3) create a thermal bridge between the thermo-active element and the structural element so as to allow greater cooling dynamics, especially in the presence of air flows confined within the structural element.

Advantageously, the longitudinal septum is made of the same material as the thermo-active element in order to allow controlled and stable thermal expansion of the apparatus.

### BRIEF DESCRIPTION OF THE DRAWINGS

Further features and advantages of the invention will become clearer from an examination of the following detailed description of a preferred, but not exclusive, embodiment, illustrated for indicative and non-limiting purposes, with the support of the attached drawings, in which:

FIG. 1 schematically shows a sectional view of an induction Multi-block heating module 100 composed of a thermal break 10, a structural support 20, two thermo-active elements 30, a longitudinal septum 60 and an inductor 40;

FIG. 2 schematically shows a sectional view of a Multi-block heating module 100 composed of two thermal breaks 10 and 11 of different lengths D and D′, a structural support 20 and three thermo-active elements 30, 35 and 36, having dissimilar volumes (volume 30 smaller than volume 32, smaller than volume 36);

FIG. 3 schematically shows a sectional view of a Multi-block heating module 100 made up of two thermal breaks 10, of equal length D and having a larger equivalent diameter than the thermo-active elements 30;

FIG. 4 schematically shows four views in orthogonal section of the position that the structural support/s 20 can assume with respect to the thermo-active element 30: FIG. 4A central coaxial, FIG. 4B peripheral, FIG. 4C two peripheral structural supports 20, FIG. 4D three structural supports 20 of which 2 are peripheral and 1 central coaxial;

FIG. 5 schematically shows a sectional view of a thermo-active element 30 characterized by the presence of three longitudinal septum 60 integral with the structural support 20 and with an extension equal to the length of the thermo-active element 30.

FIG. 6 schematically shows a sectional view of a thermo-active element 30 characterized by the presence of an orthogonal septum 50 distant from the thermo-active element 30;

FIG. 7 schematically shows a sectional view of a Multi-block heating module 100 characterized by a multilayer thermal break 10 composed of three layers (10A, 50 and 10B) of which the layer 50 is an orthogonal septum with a larger equivalent diameter of the equivalent diameter of the thermo-active elements 30;

FIG. 8 schematically shows a sectional view of an orthogonal septum 51 and 54 in the shape of a “bell” whose smaller base is integral with the structural support 20 and inside the thermo-active element 30 and the larger base has the same equivalent diameter to the thermo-active element 30 and smaller than the chamber 70 (FIG. 8A) or greater than the thermo-active element 30 and equal to the chamber 70 (FIG. 8B);

FIG. 9 schematically shows a sectional view of two thermo-active elements 30 and 31 of dissimilar equivalent diameter (30<31); the element 30 is contained in a chamber 70 characterized by an irregular shape (lower base >upper base) and longitudinal development; the orthogonal septums 52 and 53 are dissimilar in size and shape and are integral with the structural support 20 respectively in the area of the thermo-active element 30 and 31.

FIG. 10 schematically shows a sectional view of a Multi-block heating module 100 in which there is a parallel and eccentric duct cooling system 80 with respect to the structural support 20;

FIG. 11 schematically shows a sectional view of a cooling system 80 inside the Multi-block heating module where in FIG. 11A the cooling system 80 is parallel and not coaxial to the structural support 20, in FIG. 11B is parallel and coaxial and included with respect to the structural support 20, in FIG. 11C is parallel, coaxial and containing the structural support 20;

FIG. 12 schematically shows a view of a Multi-block heating module 100 characterized by the presence of an oblique duct with respect to the longitudinal axis which allows a probe 90 introduced into the structural support 20, centrally with respect to the axis, to reach the periphery, therefore the surface of the thermo-active element 30.

FIG. 13 schematically shows a sectional view of a Multi-block heating module 100 characterized by: FIG. 13A solenoid inductor 40 external to the thermo-active element 30, FIG. 13B solenoid inductor 40 inside the thermo-active element 30, FIG. 13C pancake inductor 40 and external to the thermo-active element 30, FIG. 13D pancake inductor inside the thermo-active element 30.

### DETAILED DESCRIPTION OF AN EXEMPLARY PREFERRED EMBODIMENT

The present invention refers to a Multi-block heating module 100 for longitudinally developing chambers comprising at least:
two electromagnetically inducible thermo-active elements 30;
one electromagnetic inductor 40 of said thermo-active elements, arranged inside or outside said thermo-active elements;
one structural support 20 associated with said thermo-active elements, maintaining fixed the relative spatial arrangement between said thermo-active elements at least one structural support 20;
one thermal break 10 interposed between said at least two thermo-active elements 30; at least one thermal break 10;
characterized in that the thermo-active elements 30 are hollow and that at least one longitudinal septum 60 is present inside at least one thermo-active element 30.

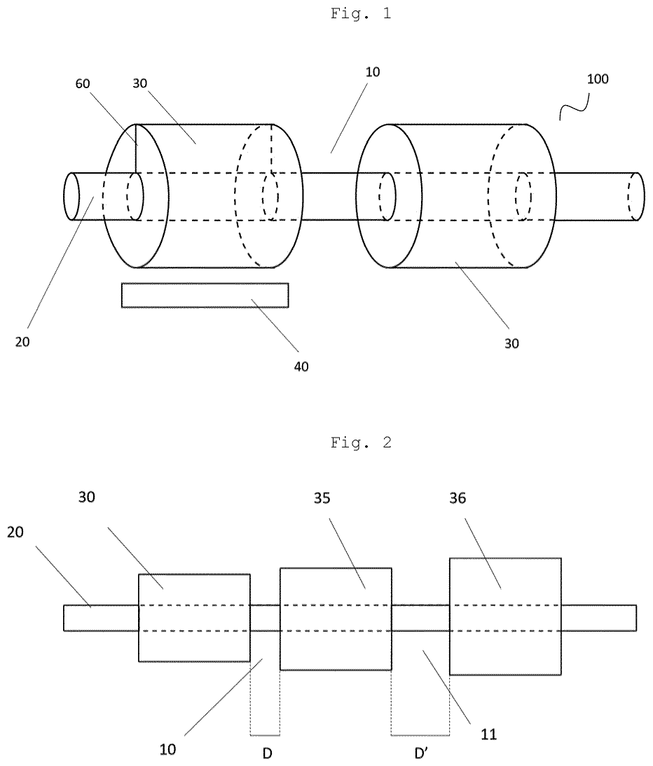

In FIG. 1 schematically represents an embodiment of a Multi-block heating module 100 composed of a structural support 20 associated with two thermo-active elements 30, separated from each other by a thermal break 10; the inductor 40 rests on the first thermo-active element 30 inside which a longitudinal septum 60 is inserted. The thermo-active element 30 is hollow to maintain low thermal inertia and allow fine temperature control and speed of response immediate. In this embodiment, the presence of the longitudinal septum 60 is decisive for maintaining the position of the structural support 20 with respect to the thermo-active element 30 as it guarantees the required distance between the structural support 20 and the thermo-active element 30; moreover, the presence of said longitudinal septum in the first thermo-active element 30 performs its function along the entire apparatus 100 without compromising the functionality of the thermal cut which limits the thermal effects to the adjacent thermo-active element 30 thus allowing a fine and different thermal control of the thermo-active elements 30. The thermo-active elements 30 have a tubular shape with a circular, polygonal or irregular section and are hollow inside with a wall thickness from 0.3 mm to 100 mm, preferably from 0. 3 mm to 10 mm; especially the thin walls have a lower thermal inertia which allows a more immediate control and a rapid thermal response. The outside diameter or equivalent outside diameter measures from 4 mm to 2000 mm, preferably from 4 mm to 80 mm for reduced heat engine development and more concentrated temperature control. The length of the single thermo-active element 30 is between 10 mm and 600 mm with preference between 15 mm and 160 mm since with the same length of the apparatus 100, more thermo-active elements of reduced dimensions allow a greater thermal differentiation along the longitudinal axis and more precise thermal control of the process.

The induction Multi-block heating module 100 has from 2 to 100 thermo-active elements 30, preferably from 2 to 15.

In one embodiment, the Multi-block heating device is characterized by thermo-active elements 30 with an embossed surface. Thanks to this embodiment, with the same dimensions, the heating surface of the thermo-active elements 30 increases; and furthermore confer aesthetic and/or mechanical characteristics to the material to be heated if placed directly in contact with the embossed surfaces of the thermo-active elements 30.

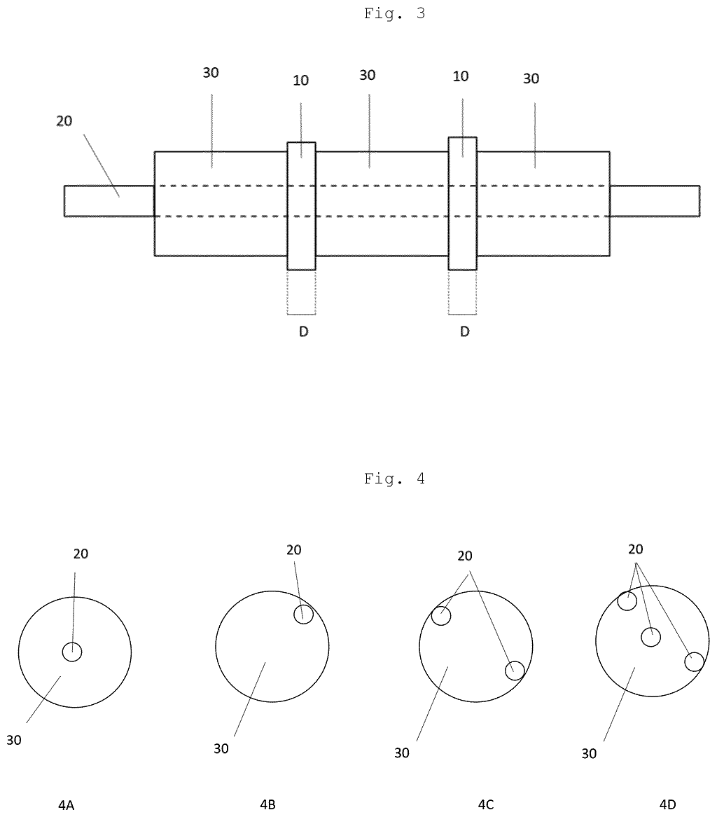

In one embodiment the Multi-block heating device is characterized by thermo-active elements having dissimilar shape and/or equivalent diameter. An example is schematically represented in FIG. 2 where the Multi-block heating device 100 has three thermo-active elements having an increasing equivalent diameter with equivalent diameters of the thermo-active elements respectively 30 less than 35 less than 36.

The thermo-active elements 30 are made of material responsive to electromagnetic fields in order to ensure the interception and electro-magnet thermal conversion of the electromagnetic fields emitted by the inductor 40.

Among the materials, the following are preferred: metals or mixtures of ferromagnetic metals, metals o mixtures of non-ferromagnetic metals or material with a metallic behavior or mixtures of materials with a metallic behavior. They are preferably made of ferritic steel, martensitic steel, stainless steel, ferromagnetic stainless steel, non-ferromagnetic steel, copper, aluminum, iron, nickel and titanium.

On the contrary, the thermal breaks 10 are mainly made of material that is not responsive to electromagnetic fields, preferably insulating materials such as air, gas, plastic material, polymers, resin, glass, ceramics, wood, conglomerate of powdered oxides, stone and/or materials compatible with Foods. Thanks to the properties of the thermal breaks 10, the thermal footprint of the device 100 is confined to the thermo-active element 30 which receives the electromagnetic waves. In fact, thermal breaks, in addition to offering poor responsiveness to electromagnetic waves, also offer optimal thermal insulation, thus presenting themselves intrinsically safe and thermally sectorial.

The thermal breaks 10 can have a distance D between two thermo-active elements 30 (as in FIG. 1) comprised between 0.1 mm and 300 mm. In one embodiment, the number of thermo-active elements 30 is equal to or greater than three and has thermal breaks 10 at different lengths. Thanks to this form of implementation it is possible to construct a more performing heating module 100 capable of conferring different thermal impressions along the longitudinal axis.

In FIG. 2 schematically represents a Multi-block heating device 100 where three thermo-active elements 30, 35 and 36 are separated from each other by two thermal breaks 10 of distance D and D′ with D different from D′.

The thermal breaks 10 can also have an equivalent diameter equal to or different from the equivalent diameter of the thermo-active elements 30; thanks to this conformation, the thermal breaks can act for example completely as guides for placing a possible external chamber on the device. FIG. 3 schematically shows a sectional view of a heating device 100 where the thermal breaks 10 have an equivalent diameter greater than the equivalent diameter of thermo-active elements 30.

In one embodiment, the thermo-active elements 30 are coupled to a support which gives them rigidity and structure as, by way of example, in the case of thermo-active elements made of metal with a thickness of less than 0.5 mm. Thanks to the reduced thickness of the metal, the Multi-block heating module 100 is very reactive to electromagnetic fields and almost instantly ready to transfer thermal energy.

The structural support 20 represents the support element of the Multi-block heating module 100 and the coupling system for integrating the module 100 into machinery. The structural support 20 is therefore made of metallic material or mixtures of metallic or dielectric material according to the mechanical requirements and the chemical-physical properties required by the system in which it is integrated.

The structural support 20 can have a length between 30 mm and 3000 mm, preferably between 100 mm and 300 mm, and a diameter between 2 mm and 600 mm, preferably between 3 mm and 60 mm.

In one embodiment, the Multi-block heating module 100 has more than one structural support 20 (e.g. FIGS. 4C and 4D) depending on the mechanical strength requirements of the module required by the application.

The structural support 20 can also be positioned coaxially and/or in a peripheral position with respect to the thermo-active elements 30. FIG. 4 shows four orthogonal schematic views of the heating device 100 where the support 20 is positioned coaxially (FIG. 4A), peripherally (FIG. 4B); in FIG. 4C shows 2 structural supports 20 in lateral positions, while in FIG. 4D shows three structural supports 20, one of which is coaxial to the thermo-active element 30 and the other two peripheral. The choice of quantity and position of the structural support 20 depends on the thermal and mechanical requirements of the process in which the apparatus 100 is integrated; for example, in the case of integration in a machine which rotates thermo-active elements 30 and central support 20, in the same direction and coaxially, with external and stationary inductor 40, the positioning of two structural supports 20, in peripheral position, to ensure greater structural solidity and stability over time of the apparatus 100 and greater resistance to any external pressure on the thermo-active elements 30.

In one embodiment, the Multi-block heating module 100 has a longitudinal septum 60 inside the thermo-active element which gives greater stability and mechanical resistance to the thermo-active element 30, above all with reference to any punctual loads along the development of the septum itself. In one embodiment, the longitudinal septum 60 is integral (for example by means of fusion, extrusion, joint, welding, subtractive processing, additive processing, . . . ) with the thermo-active element 30 to ensure greater stability and mechanical resistance.

In an additional embodiment the longitudinal septum 60 rests on the thermo-active element 30 and has a height lower than the distance between the thermo-active element 30 and the structural element 20; thanks to this form of implementation, the longitudinal septum 60 defines chambers inside the thermo-active element 30 which increase the hot contact surface with the element that passes inside it, increasing the heat transfer.

In a further embodiment the longitudinal septum 60 insists on the thermo-active element 30 and on the structural element 20 creating a mechanical and thermal bridge between the two elements; thanks to this embodiment the longitudinal septum 60 allows to:
1) increase the mechanical properties of the thermo-active element 30 since it becomes more resistant to pressure;
2) improve the positioning of the thermo-active element 30 with respect to the structural element 20 since it defines positioning guides;
3) create a thermal bridge between the thermo-active element 30 and the structural element 20 so as to allow greater cooling dynamics, especially in the presence of air flows confined within the structural element 20.

In one embodiment, the longitudinal septum 60 can be of the same material as the thermo-active element 30 in order to allow a controlled and stable thermal expansion of the apparatus 100.

In one embodiment, the longitudinal septum 60 can be of a different material than the thermo-active element 30; thanks to this form of implementation it is possible to choose the optimal thermal transfer for the application; by way of example, the expert could choose a highly insulating material such as a micaceous material, a polymer resistant to high temperatures, a ceramic, a silicone, etc. . . . to reduce the heat input inside the apparatus 100; on the contrary, the expert, for example, will choose a more conductive material to improve the heat exchange towards the inside of the apparatus 100.

In one embodiment, the longitudinal septum 60 may be multilayered; thanks to this form of implementation during the maintenance operations of the apparatus 100, it will be possible to remove one or more layers of the longitudinal septum 60, replacing them if necessary.

In one embodiment, the longitudinal septum 60 can have a planar or three-dimensional, continuous or network shape according to the needs of the application; for example, if a reduced inertial mass is required, the network conformation will be preferred or, in the event of a request for centering action towards the structural support 20, the planar or three-dimensional conformation will be preferred.

In one embodiment, the longitudinal septum 60 extends partially or wholly along the longitudinal axis of the structural support 20. FIG. 5 schematically represents a thermo-active element 30 with three longitudinal septum 60 arranged in a radial pattern along the longitudinal axis; this form of implementation is to be preferred due to the robustness and mechanical resistance of the apparatus 100 to the pressures coming from the outside. If the speed of thermal response is more preferred than the mechanical resistance to pressure, it will be advisable to prefer a longitudinal septum 60 partially developed along the longitudinal axis of the structural support in order to minimize thermal bridges between the two elements. In one embodiment, the thermal break 10 can be single-layer or multi-layer, and therefore composed of several layers that are homologous or heterologous by composition.

In one embodiment, inside the thermal break there is an orthogonal septum 50 integral with, near or distant from the thermo-active elements 30.

When integral with or in proximity to the thermo-active element 30, the orthogonal septum 50 allows for less dispersion of the thermal energy of the thermo-active element to which it is connected, acting as a side wall to the thermo-active element 30. It is configured thus, for each thermo-active element 30, a sort of closed thermal chamber able to contain more thermal energy inside it.

When distant from the thermo-active elements 30, the orthogonal septum 50 offers a more efficient insulating effect compared to a thermal break 10 composed of a homogeneous material since the thermal energy will have to transit through more material, reducing the propagation of heat at each transit.

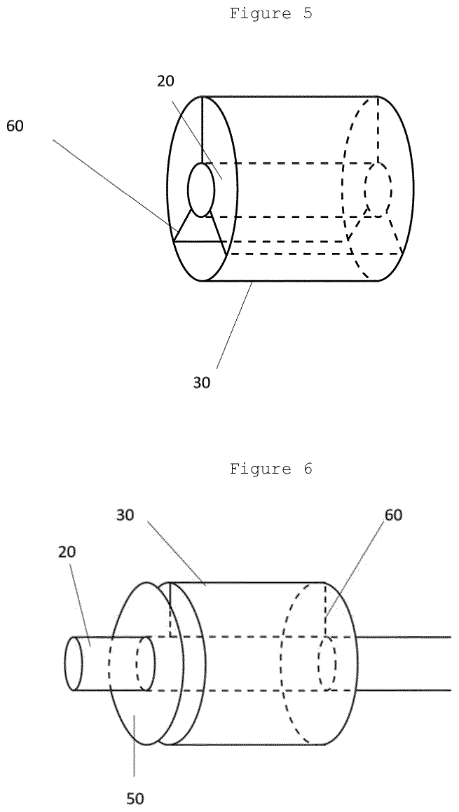

FIG. 6 schematically shows an example of conformation of the orthogonal septum 50 of the same diameter as the thermo-active element 30 of cylindrical shape.

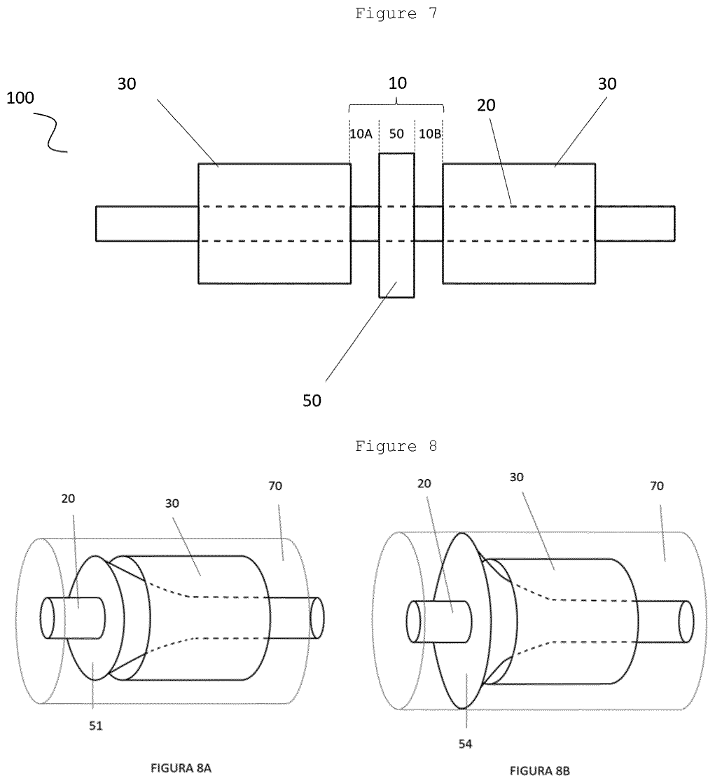

Another example is given by the implementation form of the Multi-block heating module 100 depicted in FIG. 7 where there are: two thermo-active elements 30, a structural support 20 and a thermal break 10 with an interposed orthogonal septum 50; in the FIG. 7 the thermal break 10 is composed of three layers: 10A, 50 (the orthogonal septum) and 10B. The orthogonal septum 50 has smaller dimensions than the thermo-active element 30. Again by way of example the layers 10A and 10B can be constituted by air, while the orthogonal septum 50 by metals or metal mixtures for greater mechanical resistance or by material refractory insulator such as plastic, thermosetting polymers, rubber, peek, ceramic, alumina. . . . Thanks to this embodiment it is possible to maintain a defined position between the heating module 100 and, by way of example, the chamber where it is inserted, insisting the septum orthogonal 50 directly on the walls of the chamber and thus guaranteeing the predefined distance between the thermo-active elements and the chamber itself.

In one embodiment, the orthogonal septum is integral with the structural support 20 with a base placed inside the thermo-active element 30 as shown in FIG. 8A and 8B, where the orthogonal septum 51 and 54, in the shape of a bell with an axis parallel to the structural support 20, is inserted in correspondence with the mid-length of the thermo-active part 30.

In one embodiment, the septum orthogonal to the structural support 20 has an equivalent diameter similar to or equal to the thermo-active element 30 to favor the compact development of the heating module 100 and allow easier insertion into a chamber 70 as shown in FIG. 8A.

In one embodiment, the septum orthogonal to the structural support 20 has an equivalent diameter greater than the thermo-active element 30 and less than or equal to the equivalent diameter of a possible chamber 70 to favor total (FIG. 8B) or partial adhesion of the septum orthogonal 54 to a possible chamber 70 in which the heating module 100 is inserted.

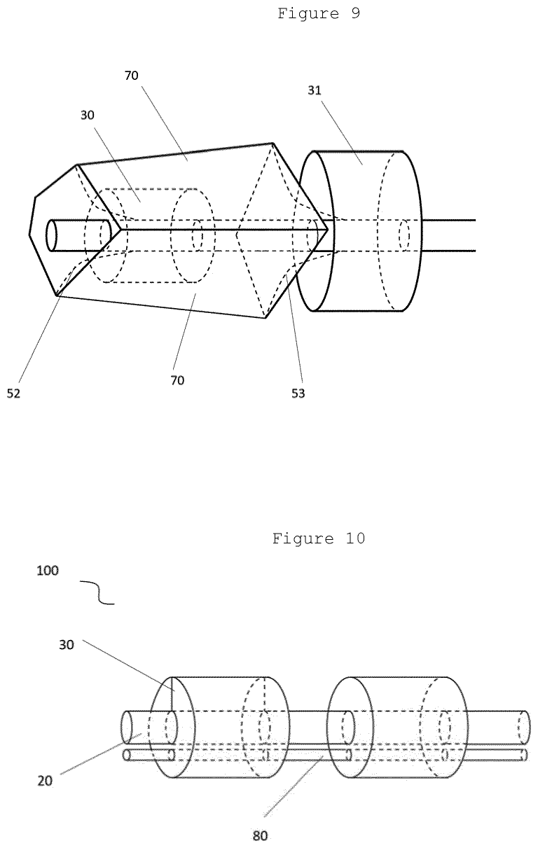

In FIG. 9 there are two thermo-active elements 30 and 31 which are different from each other (volume of the element 30 smaller than the volume of the element 31) where the chamber 70 which contains them has an irregular shape (lower base greater than the upper base) and development longitudinal; the orthogonal septums, 52 and 53, are integral with the structural support 20 respectively in the area of the thermo-active element 30 and 31 and can be integral or supportive without being mechanically joined, respectively to the lower and upper bases of the chamber 70.

In one embodiment, the apparatus 100 is inserted in a chamber 70 which transits or is stationed on the device 100; implementation forms of this type give the apparatus 100 an important versatility of use since with the same device it is possible to perform several heating functions, above all when the heating target is the chamber itself.

In one embodiment, the chamber 70 has a cylindrical or polyhedral shape similar to that of the device 100 and is 0.5 mm to 100 mm away from it. Thanks to this embodiment, the device 100 heats the chamber which thus rapidly reproduces the sectoral thermal footprint of the device 100.

In one embodiment, the Multi-block heating module 100 is equipped with an internal circulation system 80 of a heat transfer fluid, gas or liquid, including by way of example air, nitrogen, water, argon, oil, glycol water, refrigerant gases. . . . The presence of said internal circulation system 80 allows the removal of heat from the apparatus 100 and, therefore, the rapid cooling of the same (or the heating of the passing thermalvector fluid).

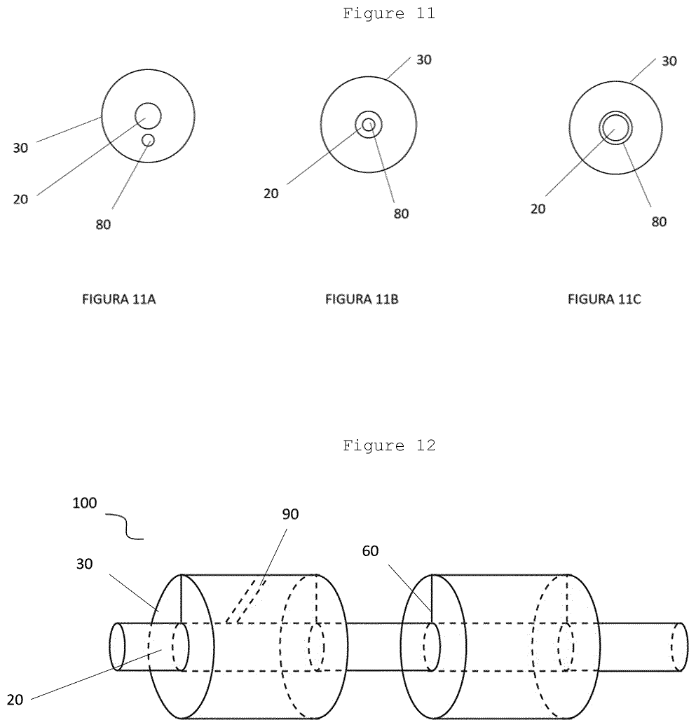

The circulation system 80 also consists of at least one longitudinal channel which at least partially covers the development in length of the axis of the heating module 100 and which can be connected to empty chambers present inside the thermo-active elements 30 and which allow the thermo-vector fluid to lap the surfaces of the thermo-active element 30, modifying its temperature. A greater extension of longitudinal channels is associated with a greater ability of apparatus 100 to alterate its temperature to the passage of the thermo-vector fluid since the contact surface between the hot wall of the thermo-active element 30 and the passing fluid will be more extensive. Internal circulation system 80 can be parallel and not coaxial to the structural support 20 (FIG. 10 and FIG. 11A), coaxial parallel and included within the overall dimensions of the structural support 20 (FIG. 11B) or coaxial parallel and inclusive of the structural support 20 (FIG. 11C).

Thanks to these embodiments, the temperatures of the thermo-active elements 30 can be modulated by managing the removal of heat by the heat transfer fluid.

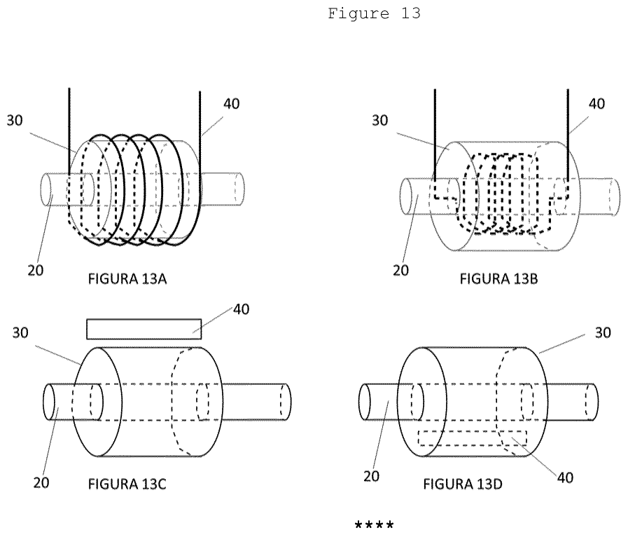

In one embodiment, the induction Multi-block heating module 100 has analytical elements inside it, such as temperature measurement probes, mechanical force measurement probes, erosive current measurement probes, etc. FIG. 12 schematically shows a sectional view of a power source module heater 100 characterized by the presence of an oblique channel with respect to the longitudinal axis which allows a probe 90 introduced into the structural support 20, centrally with respect to the axis, to reach the periphery and therefore the surface of the thermo-active element 30.

The inductor 40 of the Multi-block heating module 100 can be internal or external to the thermo-active element 30 and can have a solenoid or pancake shape and a distance of the thermo-active element between 0.5 mm and 150 mm, preferably between 0.5 mm and 50 mm to ensure the greatest electromagnetic-thermal transduction of the electromagnetic field generated by the inductor 40, the density of the lines of the electromagnetic flux being inversely proportional to the square of the distance.

In the case of a circular and small-sized apparatus 100, an external solenoid should be preferred to allow complete immersion of the thermo-active elements 30 by the electromagnetic waves; on the other hand, if a different thermal footprint is required not only by sector (vertical) but also with different thermally active zones over the entire surface of the single thermo-active element 30, a pancake inductor 40 capable of emitting electromagnetic fields will be preferred orthogonal to the support plane and incident only on the intercepted front surfaces. If the material to be heated flows outside the device 100 and a reduced size of the device is required, it will be preferable to insert the internal inductor, for example a solenoid. FIG. 13 shows some of the more conventional forms of coupling between inductor 40 and thermo-active element 30:

FIG. 13A the inductor is solenoid operated and external to the thermo-active element 30;

FIG. 13B the inductor is solenoid operated and inside the thermo-active element 30;

FIG. 13C the inductor is pancake-shaped, external to the thermo-active element 30;

FIG. 13 D the inductor is pancake-shaped, inside the thermo-active element 30.

To reduce the powers installed on the machinery which integrates the heating module 100, the solenoid inductor placed outside the thermo-active elements 30 can be movable along the longitudinal axis of the module 100 and heat the individual modules on request.

In one embodiment, the Multi-block heating module 100 is made entirely using additive 3D printing techniques; thanks to this form of implementation, the Multi-block heating module 100 is monolithic, easy to assemble and more resistant.

In one embodiment, the thermo-active elements 30 and the structural support 20 rotate simultaneously, in the same direction and coaxially while the inductor 40, internal or external to the thermo-active elements 30, is stationary, thus allowing the heating of structures moving characteristics of some production processes.

1. A Multi-block heating module for longitudinally developing chambers compring at least:
two electromagnetically inducible thermo-active elements (30);
one electromagnetic inductor (40) of said thermo-active elements, arranged inside or outside said thermo-active elements;
one structural: support (20) associated with said thermo-active elements, maintaining fixed the relative spatial arrangement between said thermo-active elements;
one thermal break (10) interposed between said at least two thermo-active elements;
characterized in that the thermo-active elements (30) are hollow and that at least one longitudinal septum (60) is present inside at least one thermo-active element (30).

2. A Multi-block heating module for longitudinally developing chambers according to claim 1 wherein the hollow thermo-active elements (30) have a tubular shape with a circular section and a wall thickness preferably from 0.3 mm to 10 mm.

3. A Multi-block heating module for longitudinally developing chambers according to the preceding claims, wherein the single thermo-active elements (30) have an outside diameter or equivalent outside diameter preferably from 4 mm to 80 mm, and a length of the single thermo-active element (30) preferably between 15 mm and 160 mm.

4. A Multi-block heating module for longitudinally developing chambers according to one or more preceding claims wherein the thermo-active elements (30) have an embossed surface.

5. A Multi-block heating module for longitudinally developing chambers according to one or more preceding claims wherein the thermo-active elements (30) are made of metal or metal mixtures, preferably of ferritic steel, martensitic steel, stainless steel, ferromagnetic stainless steel, copper, aluminum, iron, nickel or titanium.

6. A Multi-block heating module for longitudinally developing chambers according to one or more preceding claims wherein the thermal breaks (10) are made of material not responsive to electromagnetic fields, preferably insulating materials such as air, plastic material, polymers, resin, glass, ceramic, wood, oxide conglomerate in powder, stone and/or food compatible materials.

7. A Multi-block heating module for longitudinally developing chambers according to one or more preceding claims in which at least one longitudinal septum (60) has a planar or three-dimensional, continuous or network shape.

8. A Multi-block heating module for longitudinally developing chambers according to one or more preceding claims in which at least one longitudinal septum (60) extends partially or integrally along the longitudinal axis of the structural support (20).

9. A Multi-block heating module for longitudinally developing chambers according to one or more preceding claims characterized by the presence of at least one orthogonal septum (50) located between two thermo-active elements (30) and in contact with or distant from the thermo-active elements (30).

10. A Multi-block heating module for longitudinally developing chambers according to one or more preceding claims inserted inside a transit or stationary chamber (70).

11. A Multi-block heating module for longitudinally developing chambers according to one or more preceding claims equipped with an internal circulation system (80) of a gas or liquid heat transfer fluid, preferably air, nitrogen, water, argon, oil, glycol water, refrigerant gases.

12. A Multi-block heating module for longitudinally developing chambers according to the preceding claim in which the heat transfer fluid circulates inside at least one longitudinal channel positioned inside or outside the structural support (20) and which at least partially covers the longitudinal development of the heating module heating (100).

13. A Multi-block heating module for longitudinally developing chambers according to one or more preceding claims wherein the inductor (40) is internal or external to the thermo-active element (30) and can have a solenoid or pancake shape and a thermo-active element (30) distance preferably between 0.5 mm and 50 mm.

14. A Multi-block heating module for longitudinally developing chambers according to one or more preceding claims wherein the inductor (40) is movable along the longitudinal axis of the module (100).

15. A Multi-block heating module for longitudinally developing chambers according to one or more preceding claims in which the thermo-active elements 30 and the structural support (20) rotate simultaneously, in the same direction and coaxially, while the inductor (40), internal or external to the thermo-active elements (30), is stationary.
